(19) United States
(12) Patent Application Publication
(10) Pub. No.: US 2010/0096250 A1
(43) Pub. Date: Apr. 22, 2010

(54) SEA WATER DESALINATION SYSTEM AND METHOD FOR PREPARING DRINKING WATER

(75) Inventors: Hans-Jürgen Quadbeck-Seeger, Bad Durkheim (DE); Armin Alteheld, Bad Kreuznach (DE); Klaus Hahn, Kirchheim (DE); Dietrich Scherzer, Neustadt (DE); Christof Mock, Mannheim (DE); Bernhard Vath, Mannheim (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/526,404

(22) PCT Filed: Feb. 5, 2008
(86) PCT No.: PCT/EP08/51399

§ 371 Date: Aug. 7, 2009

(30) Foreign Application Priority Data
Feb. 8, 2007 (EP) 07101970.7

(51) Int. Cl. C02F 1/04; B01D 61/36

(52) U.S. Cl. 203/17; 203/12

(57) ABSTRACT

A process for obtaining process water by condensation of mist or by evaporation of water comprising salts or impurities and condensation of the evaporated water, and plants for carrying out the process and the use thereof for obtaining drinking water.

The invention relates to a process for obtaining process water by condensation of mist or by evaporation of water comprising salts or impurities and condensation of the evaporated water, and plants for carrying out the process and the use thereof for obtaining drinking water.

Open-cell foams based on a melamine/formaldehyde condensate are known for various heat- and sound-insulating applications in buildings and vehicles and as insulating and shock-absorbing packaging material.

For obtaining process and drinking water in desert regions, the dew or mist can be deposited on polypropylene nets and collected as water drops, particularly in coastal regions. However, for the collection of sufficient amounts of water, large nets and appropriate collection systems are required.

The working-up of sea water or brackish water is either very time-consuming and provides only small amounts of process water or requires complicated plants with the corresponding infrastructure, for example power supplies.

It was an object of the invention to remedy such disadvantages and to provide a process and a plant for sea water desalination, which process can be used with little means also in regions without a power supply.

Accordingly, a process for obtaining process water by condensation of mist on the struts of an open-cell foam based on an aminoplast or by evaporation of water comprising salts or impurities from the cells of an open-cell foam based on an aminoplast and condensation of the evaporated water was found.

Preferably used open-cell foams are resilient foams based on a melamine/formaldehyde condensate having a specific density of from 5 to 100 g/l, in particular from 8 to 20 g/l.

The cell count is usually in the range from 50 to 300 cells/25 mm. The mean cell diameter is as a rule in the range from 80 μm to 500 μm, preferably in the range from 100 to 250 μm.

The tensile strength is preferably in the range from 100 to 150 kPa and elongation at break in the range from 8 to 20%.

For the production, according to EP-A 071 672 or EP-A 037 470, a highly concentrated, blowing agent-containing solution or dispersion of a melamine-formaldehyde precondensate can be foamed with hot air or steam or by irradiation with microwaves and cured. Such foams are commercially available under the name Basotect® from BASF Aktiengesellschaft.

The molar melamine/formaldehyde ratio is in general in the range from 1:1 to 1:5. For the production of particularly low-formaldehyde foams, the molar ratio is chosen to be in the range from 1:1.3 to 1:1.8 and a precondensate free of sulfite groups is used, as described, for example, in WO 01/94436.

In order to improve the performance characteristics, the foams can subsequently be annealed and pressed. The foams can be cut to the desired shape and thickness and, if appropriate, laminated with an underlay for stiffening. For example, a polymer sheet or metal foil can be applied as an underlay.

The thickness of the open-cell foam depends on the size of the sea water desalination plant and is as a rule in the range from 5 to 500 mm, preferably in the range from 10 to 100 mm.

Owing to the resilience of the open-cell foam, it can be inserted into prefabricated container parts in a simple manner. Even at low temperatures, for example below −80° C., the foam remains resilient. Damage due to embrittlement does not occur. It is also suitable for the flexible insulation of moving pipelines, for example for filling hoses.

The process according to the invention is suitable in particular for sea water desalination by evaporation of a brine and condensation of the evaporated water, the brine being introduced into an open-cell foam based on an aminoplast.

The brine is concentrated, for example, by the action of sunlight with evaporation of water. By carrying out the process continuously with replenishment with fresh brine, the concentrated brine is removed from the open-cell foam and can, if appropriate, be used for salt preparation.

Surprisingly, crystallization of the salt on the struts of the open-cell foam or incrustation on the surface of the open-cell foam is not observed. Evidently, the salt in the brine is concentrated by the opposing osmotic pressure and washed out of the open-cell foam by the continuously supplied fresh brine.

The evaporation of water or salt solutions takes place more rapidly if, according to the invention, an open-cell foam based on an aminoplast is used as a support. As a result of the increased surface area of the struts of the open-cell foam, the evaporation is accelerated. As long as the foam is still impregnated or flushed with water or salt solution, there is no deposition of salt on the surface of the foam. The osmotic processes can continue taking place in the impregnated foam.

The process is preferably carried out continuously. For this purpose, the brine is passed continuously over the open-cell foam based on an aminoplast. The flow velocity of the brine is adapted according to the evaporation rate, which is determined, inter alia, by the surface area of the foam and the climatic conditions, such as temperature and incident sunlight, and the concentrating brine is washed away continuously. Blockages due to suspended particles can be avoided by brief back-washing.

Uninterrupted continuation of the evaporation can also be achieved by using floats. For this purpose, the open-cell foam based on an aminoplast is combined with floats which ensure that the surface of the aminoplast foam is always substantially above the liquid surface. Suitable floats can, for example, be produced from polystyrene particle foams (EPS) and bonded to the aminoplast foam by adhesive bonding, welding or interlocking with the aminoplast foam. The construction should be produced so that the aminoplast foam is always supplied with fresh brine via its capillary forces.

The evaporated water is preferably condensed in a bell- or funnel-shaped dish of glass or a transparent plastic and discharged via a collecting channel.

The process according to the invention permits sea water desalination also in regions where no power supply is present. There is no need to supply external energy. No salinization of the open-cell foam occurs.

The process according to the invention can also be used for purifying dirty water. The open-cell foam simultaneously acts as a filter for suspended substances. In purification by distillation, it is advantageous to modify the condensation surface so that drops run off more readily and are collected more readily and scattering by resulting drops is reduced.

If a layer of an IR absorber, e.g. graphite, is applied to the open-cell foam, the surface temperature can be increased and the evaporation rate increased. Here, the surface can be completely or partly provided with a black layer. Particularly preferably, the surface of the open-cell foam is structured, for example by a wavy surface, the cutting-in of grooves or cutting-out of wedge-shaped sections.

A radiation-absorbing layer can also be bonded to or laminated with the open-cell foam if the pores of the open-cell foam are not closed. The adhesive used cannot be too hydrophobic, so that the water absorption by the open-cell foam is not hindered.

A further process for obtaining process and drinking water is based on the condensation effect of the open-cell foam based on an aminoplast. For this purpose, dry foam can be placed, for example, in desert regions, in particular in regions close to the coast. The dew or mist occurring in particular at dusk and dawn can be deposited on the struts of the open-cell foam and stored in the cells. From a height of about 10 cm, the condensed water emerges on the bottom of the foam under the action of gravity and can be collected in a channel and passed to drums or tanks. The collected water is protected from evaporation in this way.

### EXAMPLES

An open-cell melamine/formaldehyde foam having a density of about 10 kg/m³ (Basotect® from BASF Aktiengesellschaft) was used for the examples.

### Example 1

### Evaporation through Increased Surface Area

A cylinder of Basotect® (diameter 5.5 cm, height 10 cm) impregnated with water was placed in a 250 ml beaker. The beaker and an empty beaker having the same diameter were filled with water to a level of 75 ml. The total mass of both structures was determined. After 18 h, the mass loss without Basotect® was 5 g. With the use of Basotect® for increasing the surface area, a mass loss of 13 g was observed under otherwise identical conditions.

### Example 2

Two cylindrical aluminum dishes having a diameter of about 3 cm and a height of about 1.5 cm were completely filled with cylinders of an open-cell melamine/formaldehyde foam having a density of about 10 kg/m³ (Basotect® from BASF Aktiengesellschaft). In one case, the surface area of the foam was increased by cutting a plurality of wedges out of the cylinder surface by means of a knife. 15.0 g of water were introduced in both dishes. After 24 h at room temperature, the mass loss was determined. In the case of the sample having an increased surface area, it was 10% above the value for the comparative sample.

### Example 3

### Use of Heat Radiation for Evaporation

1.71 g of graphite were incorporated superficially into a cylinder of Basotect® (diameter 56 mm, height 160 mm). The cylinder obtained and a cylinder without graphite but having the same dimensions were completely impregnated with water and placed in each case into 250 ml beakers which were filled with 75 ml of water. An IR radiator having a power of 250 W was installed at a distance of 15 cm so that both structures were irradiated to equal extents. After a duration of irradiation of 4 h, the mass loss and the surface temperature were determined. The graphite-free sample had a mass loss of 9% and a surface temperature of 51° C. The sample modified by means of graphite had lost 16% of the mass during the irradiation and had a surface temperature of 60° C.

### Example 4

### Water Treatment/Desalination

Determination of height of rise for salt solution:

Three dry Basotect® cylinders having a diameter of about 4 cm and a height of 10 cm were each placed in a 250 ml beaker. The beakers were filled with 100 ml of demineralized water or a 5% strength by mass or 10% strength sodium chloride solution. After 16 h, the height of rise of the liquid in the foam was determined. It was about 10 mm in all cases. The height of rise had little influence by electrolytes.

Evaporation of salt solution:

A cylinder of Basotect® (diameter 5.5 cm; height 10 cm) was impregnated in a 5% strength by mass solution of sodium chloride and placed in a 250 ml beaker. The vessel was filled with the salt solution up to the 75 ml mark. Exactly the same procedure was adopted with a second cylinder having the same dimensions, but a salt solution having a concentration of 10% by mass was used. Both structures were irradiated with an IR radiator having a power of 250 W from a distance of 40 cm for 7 h. The mass loss was 15 g in the case of the 5% strength salt solution, while 14 g of water had evaporated in the case of the 10% strength salt solution. The salt concentration of the more highly concentrated solution in the foam and in the beaker was determined gravimetrically after the irradiation. It was 10.6% in the beaker while it had a value of 10.9% in the foam. No salt deposition on the surface of the foam was observed.

### Example 5

### Distillation

Two disc-shaped test specimens of Basotect® were impregnated with a 3% strength aqueous solution of sodium chloride. The mass of the impregnated test specimens was 121.7 g in each case. The impregnated foams were each placed in a glass dish. In each case 1.5 L of PET beverage bottles from which the tapering bottle neck had been cut off (tube closed at one end) were inverted over the test specimens. One of the PET coverings obtained was impregnated in the interior with a hydrophilic nanostructured coating which accelerated the run-off behavior of water. As a result of the chosen structure, liquid evaporated from the foam could condense on the surrounding PET walls. The condensate could be collected in the dish. The two bottles were irradiated with an IR radiator (250 W) from a distance of about 40 cm to equal extents. After a duration of radiation of 1 h, the mass loss of the impregnated foam with the use of the unmodified PET covering was 4.6% by mass, and 3.0 g of water were collected in the dish. With use of the modified PET covering, 5.9% by mass of the water evaporated and 3.6 g of water were collected. Numerous drops which had not run off were visible on the unmodified PET surfaces, whereas the modified surface was optically dear.

1.-9. (canceled)

10. A process for obtaining process water by condensation of mist on struts of an open-cell foam based on an aminoplast or by evaporation of water comprising salts or impurities from the cells of an open-cell foam based on an aminoplast and condensation of the evaporated water.

11. The process according to claim 10, wherein sea water desalinated by evaporating a brine and condensating the evaporated water, wherein the brine is introduced into an open-cell foam based on an aminoplast.

12. The process according to claim 11, wherein the brine is passed continuously over the open-cell foam based on an aminoplast.

13. The process according to claim 10, wherein the open-cell foam has a specific density in the range from 5 to 100 g/l.

14. The process according to claim 10, wherein the open-cell foam was produced from a melamine/formaldehyde condensate having a molar melamine/formaldehyde ratio in the range from 1:1 to 1:5.

15. The process according to claim 10, wherein the surface is completely or partly provided with a black layer.

16. The process according to claim 10, wherein the evaporated water is condensed in a bell-shaped or funnel-shaped dish of glass or a transparent plastic and discharged via a collecting channel.

17. The process according to claim 10, wherein the open-cell foam has a cell count from 50 to 300 cells/25 mm and a diameter in the range from 80 μm to 500 μm.

18. The process according to claim 12, wherein the open-cell foam has a specific density in the range from 8 to 20 g/l.

19. The process according to claim 18, wherein the open-cell foam has a cell count from 50 to 300 cells/25 mm and a diameter in the range from 100 μm to 250 μm.

20. The process according to claim 19, wherein the open-cell foam was produced from a melamine/formaldehyde condensate having a molar melamine/formaldehyde ratio in the range from 1:1.3 to 1:1.8.

21. The process according to claim 20, wherein the surface is completely or partly provided with a black layer.

22. The process according to claim 21, wherein the evaporated water is condensed in a bell-shaped or funnel-shaped dish of glass or a transparent plastic and discharged via a collecting channel.

23. A water treatment plant for carrying out the process according to claim 10, comprising an open-cell foam based on an aminoplast as a water store.

24. A process for obtaining drinking water which comprises utilizing an open-cell foam based on an aminoplast.

25. A process for obtaining process water which comprises condensating a mist on struts of an open-cell foam based on an aminoplast or evaporating water comprising salts or impurities from the cells of an open-cell foam based on an aminoplast and condensating the evaporated water.
